(19) United States
(12) Patent Application Publication
(10) Pub. No.: US 2008/0310305 A1
(43) Pub. Date: Dec. 18, 2008

(54) Interruption control

(75) Inventor: Michael M. Lee, San Jose, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: Apple Inc.

(21) Appl. No.: 11/818,767

(22) Filed: Jun. 14, 2007

(51) Int. Cl. H04J 3/14; H04M 3/42

(52) U.S. Cl. 370/235; 379/215.01

(57) ABSTRACT

A communications system in which a user may control interruptions to ongoing communications operations is provided. Using a communications device, a user may perform any suitable communications operation (e.g., voice, video or data communications). In response to receiving a communications request from another device, the communications device may determine whether the other device is authorized to interrupt the ongoing communications operation using any suitable approach (e.g., priority rankings of devices, or specific exceptions for certain devices). The interruption, if authorized, may be in any suitable form including, for example, audio interruptions, visual interruptions, physical interruptions, or any other suitable interruption type.

### BACKGROUND OF THE INVENTION

This invention is directed to a communications device in which users may control interruptions to ongoing communications operations.

With existing communications devices, users may perform different types of communications operations by interfacing, over a communications network, with other devices. For example, a user may use a telephone to connect to another telephone (e.g., by dialing a telephone number) to perform a voice communications operation. As another example, a user may use a device that is connected to the Internet to perform a data communications operation (e.g., transmit a message to another device that is connected to the Internet, for example using a chat application).

With many existing systems, when a user is performing a communications operation with a communications device (e.g., making a telephone call, or sending a data or media message), incoming communications requests interrupt the ongoing communications operation to inform the user of the incoming request. For example, while a user is making a telephone call, the telephone may produce a sound (e.g., a beep) to indicate the incoming telephone call. As another example, while a user is chatting (e.g., while the user is typing a response, or while the user is waiting for a response from another party), the device with which the user is chatting (e.g., a computer, or a mobile e-mail or chatting device, such as a Sidekick® by T-Mobile or a computer) may produce a sound, cause a different chat window to appear, provide a visual indication (e.g., a flashing icon), or perform combinations of these interruptions when an incoming chat request or chat communication is received. The interruptions often appear for all incoming communications requests, independent both of the device transmitting the new communications request device and of the device with which the communications device is performing the ongoing communications operation.

While it may sometimes be useful to interrupt ongoing communications operations (e.g., when a user is expecting an important call), interruptions may not always be desirable. There is a need, therefore, to provide a system by which a user may control interruptions of ongoing communications operations. In particular, there is a need to provide a system by which a user may provide rules for determining when a communications operation may be interrupted, which communications operations may be interrupted, and which devices may interrupt ongoing communications operations.

### SUMMARY OF THE INVENTION

A system by which a user may control interruptions to communications operations performed by a communications device is provided.

The communications device may be any suitable device for performing a communications operation. For example, the communications device may include a cellular telephone, a personal e-mail or messaging device, a computer, a personal digital assistant (PDA), or any other suitable electronic device operative to perform a communications operation. The communications operation may include, for example, audio communications (e.g., telephone conversations or video conferences), data communications (e.g., text and media messaging, e-mail, chatting), combinations of audio and data communications, or any other suitable communication.

The communications device may perform a communications operation with any other device present in a communications network that includes the communications device. To perform a communications operation, the communications device may transmit a communications request to another device, or may accept an incoming communications request from another device.

In some embodiments, while the communications device is performing a communications operation with a first device, a second device may transmit a request to initiate a communications operation with the communications device. To limit undesired interruptions of ongoing communication operations, the communications device may determine, in response to receiving the communications request, whether the second device is authorized to interrupt communications operations between the communications device and the first device. For example, the communications device may determine, from received user indications, whether the first device has a higher priority than the second device. As another example, the communications device may automatically determine whether the first device has a higher priority than the second device.

The communications device may store interruption authorization information for each device with which the communications device may perform a communications operation. For example, the communications device may store associations of ranks, tiers, or both with each device. The rank or tier may be selected such that devices with higher ranks or tiers are authorized to interrupt communications of devices having lower ranks or tiers. As another example, the communications device may store exceptions to the tier or rank associations, or specific authorizations for particular devices (e.g., an authorization for a particular device to interrupt communications between the communications device and specific other devices).

In some embodiments, the user may activate or deactivate particular interruption authorizations by activating modes of operation of the communications device. For example, in a “meeting” mode, the communications device may prevent all interruptions of an ongoing communications operation except for interruptions from a limited number of specific devices (e.g., only a spouse or child may interrupt a communications operation while the “meeting” mode is in use).

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a schematic view of a communications system in accordance with one embodiment of the invention;

FIG. 2 is a schematic view of a communications device in accordance with one embodiment of the invention;

FIG. 3 is a schematic view of an illustrative data structure for ranking devices with which the communications device may perform communications operations in accordance with one embodiment of the invention;

FIG. 4 is another illustrative data structure for ranking devices with which the communications device may perform communications operations in accordance with one embodiment of the invention;

FIG. 5 is an illustrative data structure of interruption control information for a device in accordance with on embodiment of the invention;

FIG. 6 is a flowchart of an illustrative process for determining whether to interrupt a current communications operation in accordance with one embodiment of the invention; and

FIG. 7 is a flowchart of an illustrative process for setting priorities for devices in accordance with one embodiment of the invention.

### DETAILED DESCRIPTION

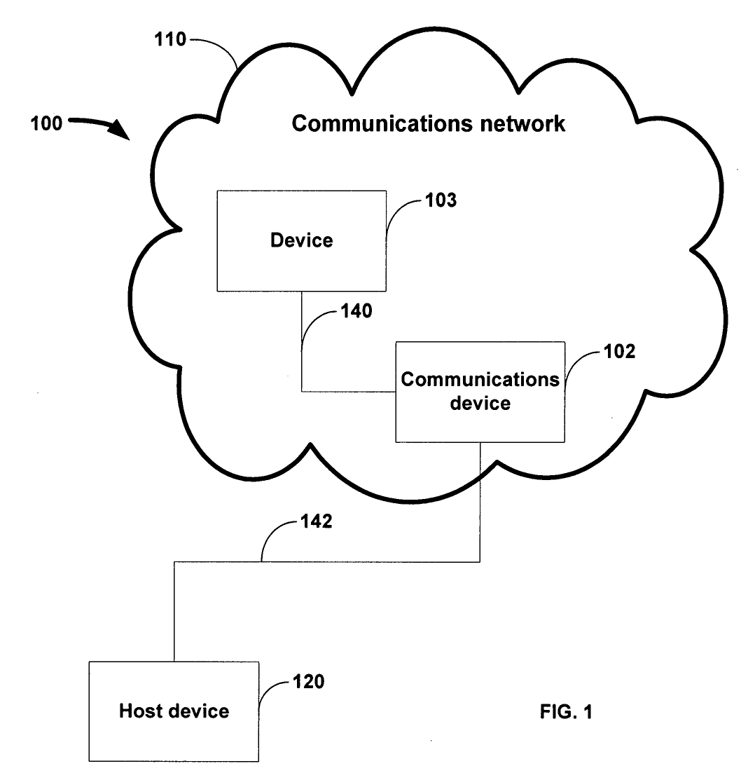

FIG. 1 is a schematic view of a communications system in accordance with one embodiment of the invention. Communications system 100 may include communications device 102, and communications network 110, which communications device 102 may use to perform wireless communications with other devices within communications network 110 (e.g., device 103). Although communications system 100 may include several of communications devices 102, devices 103, and hosts 120, only one of each is shown in FIG. 1 to avoid overcomplicating the drawing.

Any suitable circuitry, device, system or combination of these (e.g., a wireless communications infrastructure including communications towers and telecommunications servers) operative to create a communications network may be used to create communications network 110. Communications network 110 may be capable of providing wireless communications using any suitable short-range or long-range communications protocol. In some embodiments, communications network 110 may support, for example, Wi-Fi (e.g., a 802.11 protocol), Bluetooth (registered trademark), high frequency systems (e.g., 900 MHz, 2.4 GHz, and 5.6 GHz communication systems), infrared, other relatively localized wireless communication protocol, or any combination thereof. In some embodiments, communications network 110 may support protocols used by wireless and cellular phones and personal email devices (e.g., a Blackberry®). Such protocols can include, for example, GSM, GSM plus EDGE, CDMA, quadband, and other cellular protocols. In another example, a long range communications protocol can include Wi-Fi and protocols for placing or receiving calls using VOIP or LAN. Communications device 102 and device 103, when located within communications network 110, may wirelessly communicate over a local wireless communication path such as path 140.

Communications device 102 and device 103 may be any suitable device for sending and receiving communications. For example, communications device 102 and device 103 may include a media player such as an ipod available by Apple Inc., of Cupertino, Calif., a cellular telephone, a personal e-mail or messaging device (e.g., a Blackberry® or a Sidekick®), an iphone available from Apple Inc., pocket-sized personal computers such as an iPAQ Pocket PC available by Hewlett Packard Inc., of Palo Alto, Calif., personal digital assistants (PDAs), a desktop computer, a laptop computer, and any other device capable of communicating wirelessly (with or without the aid of a wireless enabling accessory system). The communications sent and received may be any suitable form of communications, including for example, voice communications (e.g., telephonic communications), data communications (e.g., e-mails, text messages, media messages), or combinations of these.

In some embodiments, communications device 102 or device 103 may be coupled to host device 120 for data transfers, synching the communications device, software or firmware updates, or performing any other suitable operation that may require communications device 102 and host device 120 to be coupled. In some embodiments, several communications devices 102 may be coupled to host 120 to share data using host 120 as a server. In some embodiments, communications device 102 may be coupled to several host devices 120 (e.g., for each of the plurality of host devices 120 to serve as a backup for data stored in communications device 102).

Communications device 102 may be coupled with host device 120 over communications link 142 using any suitable approach. For example, communications device 102 may use any suitable wireless communications protocol to connect to host device 120 over communications link 142. As another example, communications link 142 may be a wired link that is coupled to both communications device 102 and host device 120. As still another example, communications link 142 may include a combination of wired and wireless links (e.g., an accessory device for wirelessly communicating with communications device 102 is coupled by a wire to host device 120). Any suitable connector, dongle or docking station may be used to couple communications device 102 and host device 120. A more detailed discussion of a dongle or docking station that can be plugged into communications device 102 can be found, for example, in U.S. patent application publication No. 2004-0224638, which is incorporated by reference in its entirety herein.

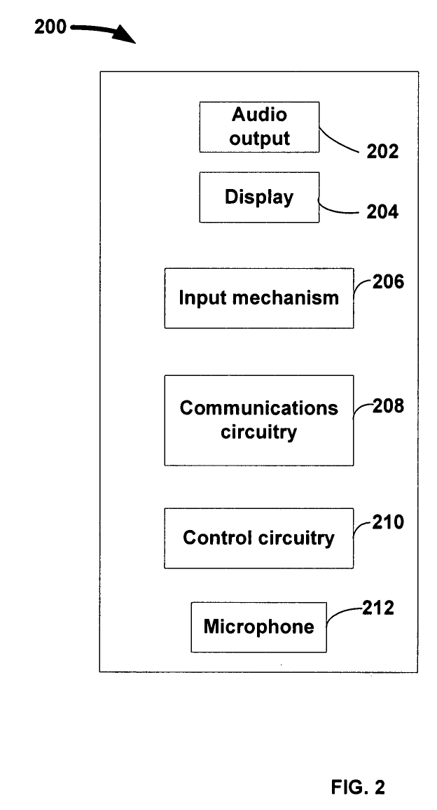

FIG. 2 is a schematic view of a communications device in accordance with one embodiment of the invention. Communications device 200 may include audio output 202, display 204, input mechanism 206, communications circuitry 208, control circuitry 210 and microphone 212.

Audio output 202 may include any suitable audio component for providing audio to the user of communications device 200. For example, audio output 202 may include one or more speakers (e.g., mono or stereo speakers) built into communications device 200. In some embodiments, audio output 202 may include an audio component that is remotely coupled to communications device 200. For example, audio output 202 may include a headset, headphones or earbuds that may be coupled to communications device with a wire (e.g., coupled to communications device 200 with a jack) or wirelessly (e.g., Bluetooth® headphones or a Bluetooth® headset).

Display 204 may include any suitable screen or projection system for providing a display visible to the user. For example, display 204 may include a screen (e.g., an LCD screen) that is incorporated in communications device 200. As another example, display 204 may include a movable display or a projecting system for providing a display of content on a surface remote from communications device 200 (e.g., a video projector). Display 204 may be operative to display content (e.g., information regarding ongoing communications operations, information regarding incoming communications requests, interruptions, or device operation screens) under the direction of control circuitry 210.

Input mechanism 206 may be any suitable mechanism for providing user inputs or instructions to communications device 200. Input mechanism 206 may take a variety of forms, such as a button, keypad, dial, a click wheel, or a touch screen. The user interface may include a multi-touch screen such as that described in U.S. Pat. No. 6,323,846, which is incorporated by reference herein in its entirety. The user interface may emulate a rotary phone or a multi-button keypad, which may be implemented on a touch screen or the combination of a click wheel or other user input device and a screen. A more detailed discussion of such a rotary phone interface may be found, for example, in U.S. patent application Ser. No. 11/591,752, filed Nov. 1, 2006, entitled “Touch Pad with Symbols based on Mode,” which is incorporated by reference herein in its entirety.

Communications circuitry 208 may be any suitable communications circuitry operative to connect to a communications network (e.g., communications network 110, FIG. 1) and to transmit communications (e.g., voice or data) from communications device 200 to other devices within the communications network. Communications circuitry 208 may be operative to interface with the communications network using any suitable communications protocol such as, for example, Wi-Fi (e.g., a 802.11 protocol), Bluetooth (registered trademark), high frequency systems (e.g., 900 MHz, 2.4 GHz, and 5.6 GHz communication systems), infrared, GSM, GSM plus EDGE, CDMA, quadband, and other cellular protocols, VOIP, or any other suitable protocol.

In some embodiments, communications circuitry 208 may be operative to create a communications network using any suitable communications protocol. For example, communications circuitry 208 may create a short-range communications network using a short-range communications protocol to connect to other devices. For example, communications circuitry 208 may be operative to create a local communications network using the Bluetooth® protocol to couple communications device 208 with a Bluetooth® headset.

Control circuitry 210 may be operative to control the operations and performance of communications device 200. Control circuitry 210 may include, for example, a processor, a bus (e.g., for sending instructions to the other components of communications device 200), memory, storage, or any other suitable component for controlling the operations of communications device 200. In some embodiments, a processor may drive the display and process inputs received from the user interface. The memory and storage may include, for example, cache, Flash, ROM, and/or RAM. In some embodiments, memory may be specifically dedicated to storing firmware (e.g., for device applications such as an operating system, user interface functions, and processor functions). In some embodiments, memory may be operative to store information related to other devices with which the communications device performs communications operations (e.g., ranking information, devices which are authorized to interrupt, or tier information).

In some embodiments, communications device 200 may include microphone 212. For example, communications device 200 may include microphone 212 to allow the user to transmit audio (e.g., voice audio) during a communications operation. Microphone 212 may be incorporated in communications device 200, or may be remotely coupled to communications device 200. For example, microphone 212 may be incorporated in wired headphones, or microphone 212 may be incorporated in a wireless headset.

Communications device 200 may include any other component suitable for performing communications operations. For example, communications device 200 may include a power supply, ports or interfaces for coupling to a host device, a secondary input mechanism (e.g., an ON/OFF switch), or any other suitable component.

A user may direct the communications device to perform a communications operation in any suitable manner. For example, a user may receive a communications request from another device (e.g., an incoming telephone call), and initiate a communications operation by accepting the communications request. As another example, the user may initiate a communications operation by identifying another device and transmitting a request to initiate a communications operation (e.g., dial a telephone number, or select a chat screen name and send a chat request).

While a user is performing a communications operation (e.g., having a telephone conversation) with the communications device, other devices may transmit requests to initiate communications operations with the busy communications device. To limit the distraction of undesired interruptions, or to ensure that communications requests from particular devices are always identified to a user performing an ongoing or in-progress communications operation, the communications device may control interruptions caused by incoming communications requests.

To control interruptions, the communications device may limit interruptions based on the device with which a current communications operation is performed, based on the device transmitting a communications request, or a combination thereof. In some embodiments, the communications device may associate rankings or tiers with some or all of the devices with which the communications device may perform communications operations. The communications device may then compare the rankings or tiers of the interrupting device and of the device with which a communications operation is being performed to identify the device with the higher ranking or tier. If the interrupting device has the higher ranking or tier, the interrupting device may be authorized to interrupt the ongoing communications operation. Conversely, if the device with which a communications operation is being performed has the higher ranking or tier, the interrupting device may not be authorized to interrupt the ongoing communications operation.

The communications device may provide rankings of devices in any suitable manner. In some embodiments, the communications device may receive rankings or tiers from the user. For example, the user may provide ranking or tier information for devices known to the communications device (e.g., devices listed in an address book or in a call history). The user may provide the rankings or tiers in any suitable manner including, for example, by entering ranking information for devices identified on display screen 204 with input mechanism 206 (FIG. 2). As another example, the user may provide ranking or tier information using a host device (e.g., host device 120), and transmit the information from the host device to the communications device (e.g., when the communications device is synched with the host device). The user may provide ranking or tier information using any suitable display interface for interacting with the device. For example, the user may sort devices in a ranked list. As another example, the user may assign ranks or tiers to devices of a listing.

In some embodiments, the communications device may automatically rank devices. For example, the communications device may assign a default ranking to each new device identified by the communications device (e.g., a ranking in or near the middle, or a default tier). As another example, the communications device may monitor user interactions with the communications device and assign rankings or tiers based on the user interactions. The communications device may monitor any suitable interaction to identify relevant information for ranking devices. Such interactions may include, for example, the devices with which the communications device performs more communications operations (e.g., telephone contacts often called), the devices for which the user ignores or acknowledges interruptions (e.g., devices to which the user switches despite a current communications operation), devices for which particular identifying information is provided (e.g., devices in an address book, devices associated with common tags such as work, home, husband, wife, child), or any other suitable interaction.

In some embodiments, instead of or in addition to allowing or preventing an interruption, the communications device may provide different types of interruptions based on the interrupting device and on the device with which the ongoing communications operation is performed. The interruption may take any suitable form. For example, the interruption may include an audio interruption (e.g., a tone or an audio clip), a visual interruption (e.g., a pop-up display, a change in the color or lighting of the display, or a change in the elements displayed), a physical interruption (e.g., a vibration of the communications device), combinations of these interruptions, or any other suitable interruption. In some embodiments, the communications device may automatically end the ongoing communications operation and begin a communications operation with the interrupting device (e.g., after providing an audio message to the communications device indicating that the communication will be switched in 10 seconds). The interruption may include any suitable information, including for example, the identity of the interrupting device, the time at which the incoming communications request was received, the priority of the interrupting device, and the priority of the device performing the ongoing communications operation.

In some embodiments, the interruption may be different based on the interrupting device, the interrupting device rank, the difference between the ranks of the interrupting device and currently communicating device, or any other suitable criteria. For example, the interruptions may include an audio signal that increases in volume with the interrupting device rank (e.g., the communications device provides the loudest interruption for the highest ranked device). As another example, the audio interruption selected may be related to the difference in rank between the devices of the current communications operation and the incoming communications request (e.g., the beat or pitch of the audio interruption may increase with the difference in rank).

In some embodiments, the user may associate different interruptions (e.g., different tones for an audio interruption, or different color schemes for a visual interruption) with different devices or rankings. For example, the user may use a ring tone associated with an interrupting device as the interrupting audio. In some embodiments, the communications circuitry may provide only visual interruptions for some devices (e.g., devices ranking lower than the device performing the ongoing communications operation), and audio, physical, or visual and audio and/or physical interruptions for other devices (e.g., devices ranking higher than the device performing the ongoing communications operation).

In some embodiments, the communications device may identify both the user of the device transmitting an interrupting communications request, and the location from which the user is transmitting the communications request. For example, the interrupting device may transmit a name associated with the device (e.g., the name of the cellular telephone subscriber, or the email address or chat handle of the user) and the address or nearby landmarks (e.g., a hospital or a school) of the user (e.g., using a GPS component of the device, or triangulation between the device and the sources of the communications network). The communications device may be operative to authorize or prevent interruptions from particular users unless they are located near a particular area (e.g., interruptions from children who are calling from a location other than school during school hours). In some embodiments, the communications device may conversely be operative to authorize or prevent interruptions based on the location from which the device is transmitting the communications request (e.g., authorize interruptions from devices located at or near hospitals). In some embodiments, devices may be authorized to interrupt ongoing communications operations based on the time at which the interruption occurs.

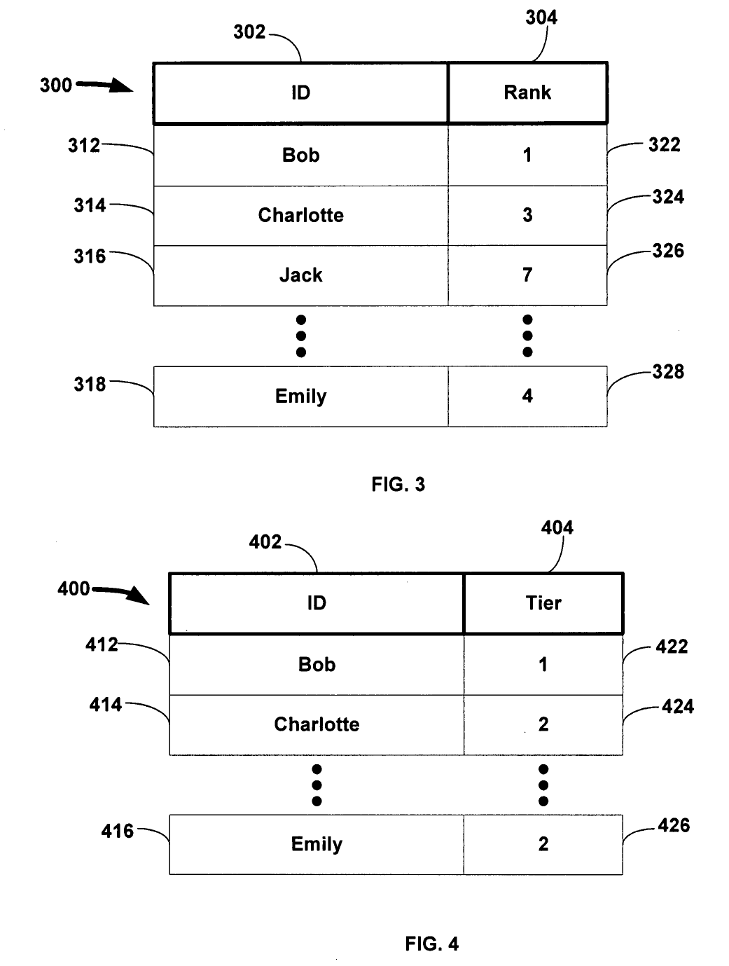

The communications device may store information related to the interruption authorizations of the devices with which the communications device performs communications operations in any suitable manner. FIG. 3 is a schematic view of an illustrative data structure for ranking devices with which the communications device may perform communications operations in accordance with one embodiment of the invention. Data structure 300 may include a table with ID column 302 and rank column 304. ID column 302 may include information identifying different devices with which the communications device may perform communications operations. For example, ID column 302 may include an entry with identification information for all devices that have sent a communications request to the communications device. As another example, ID column 302 may include an entry with identification information for all devices to which the communications device has sent a communications request.

The identification information stored in column 302 may include any suitable information for identifying a device. In some embodiments, the identification information may include information specific to each device (e.g., a serial number or SIM card number) that may be transmitted during an initial communications operation. In some embodiments, the identification information may include an address (e.g., an e-mail address, an IP address, or a telephone number) to which communications requests may be sent. In some embodiments, the identification information may include information identifying particular users. For example, if users log in to devices to perform communications operations, the devices may provide the user's login to identify the user when initiating a communications operation. Data structure 300 may then assign a rank to each user in addition to or instead of assigning a rank to each device used by each user. In some embodiments, the user of the communications device may identify particular devices by associating a name with identification information used by the communications device (e.g., associate a name with a telephone number for display to the user).

ID column 302 may include identification information in each of entries 312, 314, 316 and 318. Although the information in entries 312, 314, 316 and 318 in FIG. 3 may be the names of users, it will be understood that any other identification information, or combinations of identification information (e.g., serial numbers, e-mail addresses and telephone numbers) may be used. Data structure 300 may include any suitable number of entries in column 302. In some embodiments, the number of entries may be limited by the size of the memory or storage available for storing data structure 300. If the memory or storage is limited, the control structure may automatically remove entries for some entries. For example, the control circuitry may remove entries based on the frequency of their use, their ranking, user indications, or any other suitable criteria.

Rank column 304 may include a rank for each entry of column 302. The rank in column 304 may indicate the priority of each entry of ID column 302 relative the other entries of ID column 302. The rank entered in column 304 may be in any suitable form. For example, the ranks may include integers or rational numbers (e.g., consecutive natural numbers). As another example, the ranks may include any other suitable character or character string that can be compared to other characters or character strings.

Rank column 304 may include rank values in entries 322, 324, 326 and 328. Although the information in entries 322, 324, 326 and 328 in FIG. 3 may be a series of integers, it will be understood that any other rank values may be used in column 304.

When the communications device identifies a new device not yet present in data structure 300 (e.g., the communications device receives a new incoming communications request, or identifies a new device from an outgoing communications request), the communications device may add new entries in ID column 302 and rank column 304 for the new device. The communications device may use any suitable information that uniquely identifies the new device for the new entry in column 302. If the user does not specify a rank, the communications device may associate a default rank to the new device. In some embodiments, the communications device may re-assign the ranks in column 304 to account for the new device (e.g., if the ranks are consecutive integers, the communications device may increase the integer associated with the rank of all of the devices that are ranked lower than the new device).

A communications device that includes data structure 300 may determine whether a communications request that interrupts a current communications operation is authorized by using the rankings of column 304. For example, the communications device may identify the device with which an ongoing communications operation is performed, and the device transmitting the communications request. The communications device may then identify the rankings associated with each of the identified devices, and identify the higher ranking device. If the device with which the ongoing communications operation is performed is ranked higher, the interrupting device may be prevented from interrupting the ongoing communications operation. If instead the interrupting device is ranked higher, the communications device may interrupt the ongoing communications operation (e.g., the communications device may emit a sound, for example a tone, to indicate the received communications request).

FIG. 4 is another illustrative data structure for ranking devices with which the communications device may perform communications operations in accordance with one embodiment of the invention. Data structure 400 may include a table with ID column 402 and tier column 404. ID column 402 may include information identifying different devices for which the communications device has a record. Entries 412, 414, 416 and 418 of ID column 402 may include any of the information described above in connection with entries 312, 314, 316 and 318 of ID column 302 (FIG. 3).

Tier column 404 may include a tier for each entry of column 402. The tier in column 404 may indicate the priority of each entry of column 402 relative to the other entries. Using tiers, several devices may be given the same priority. Tiers may be entered in column 404 in any suitable form. For example, the tiers may include integers or rational numbers (e.g., consecutive natural numbers). As another example, the tiers may include any other suitable character or character string that can be compared to other characters or character strings.

Tier column 404 may include tiers in entries 422, 424, 426 and 428. Although the information in entries 422, 424, 426 and 428 of FIG. 4 may be a series of integers, it will be understood that any other tier may be used in column 404.

When the communications device identifies a new device not yet present in data structure 400 (e.g., the communications device can receive a communications request from a new device, or can transmit a communications request to a new device), the communications device may add new entries in ID column 402 and tier column 404 for the new device. The communications device may use any suitable information that uniquely identifies the new device for the new entry in column 402. If the user does not specify a tier, the communications device may associate a default tier to the new device in the appropriate entry of column 404.

A communications device that includes data structure 400 may determine whether a communications request that interrupts an ongoing communications operation is authorized by using the tiers of column 404. For example, the communications device may identify the device with which an ongoing communications operation is performed, and the device transmitting the communications request. The communications device may then identify the tiers associated with each of the identified devices. If the device of the ongoing communications operation is associated with the higher tier, the communications device may not interrupt the communications operation. If instead the device transmitting the communications request is associated with the higher tier, the communications device may interrupt the ongoing communications operation (e.g., the communications device may emit a sound, for example a tone, to indicate the received communications request). In some embodiments, the communications device may or may not interrupt a communications operation if both the device with which the ongoing operation is performed and the device transmitting the communications request are associated with the same tier.

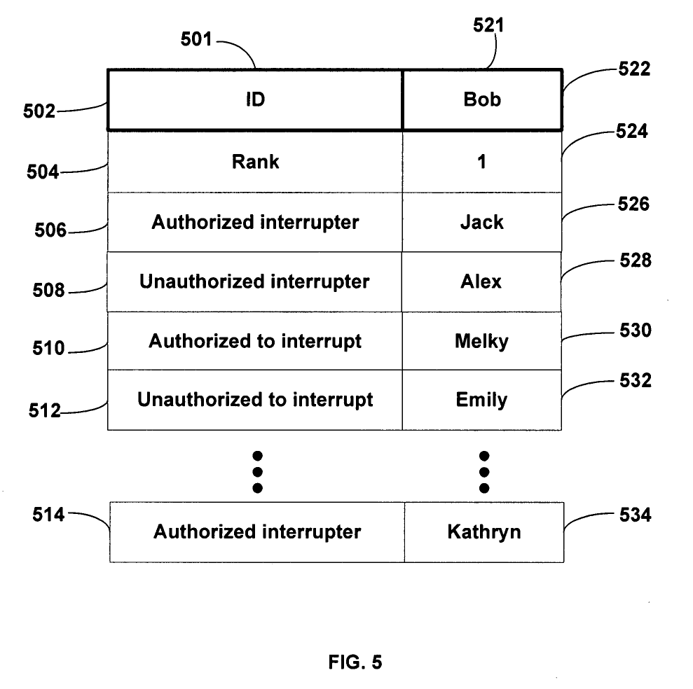

FIG. 5 is an illustrative data structure of interruption control information for a device in accordance with an embodiment of the invention. In some embodiments, a data structure 500, which may be stored in the communications device, may be associated with each device with which the communications device may perform communications operations. Data structure 500 of a particular device may include information identifying the devices whose communications operations the particular device is authorized to interrupt (e.g., authorized to interrupt), and the devices that are authorized to interrupt the communications operations of the particular device (e.g., authorized interrupters).

Data structure 500 may include a table with interruption field column 501 and interruption data column 521. Interruption field column 501 may include several entries identifying fields for which interruption information may be provided. Interruption data column 521 may include several entries associated with the interruption field entries of column 501.

Interruption field column 501 may include device ID field 502, and interruption data column 521 may include associated identification information entry 522. Entry 522 in column 521 (i.e., that is associated with device ID field 502) may including information identifying the particular device with which data structure 500 is associated. The identification information of entry 522 may include any suitable information for identifying the particular device including, for example, any of the information provided in column 302 of data structure 300 (FIG. 3) or in column 402 of data structure 400 (FIG. 4).

Interruption field column 501 may include rank field 504. Interruption data column 521 may include associated rank entry 524 for identifying the rank of the particular device identified in entry 522. In some embodiments, data structure 500 may include a tier field and associated tier entry instead of or in addition to rank field 524.

Interruption field column 501 may include authorized interrupter fields 506 and 514. Interruption data column 521 may include associated identification information entries 526 and 534. The devices identified in entries associated with fields 506 and 514 may be authorized to interrupt communications operations with the particular device identified in entry 522. In some embodiments, devices identified as authorized interrupters (e.g., devices identified in entries 526 and 534) may or may not override authorizations to interrupt based on the ranks of the devices (e.g., interrupt even though a device is associated with a rank that would not allow interruptions).

Interruption field column 501 may include unauthorized interrupter field 508. Interruption data column 521 may include associated identification information entry 528. The device identified in an entry associated with field 508 may not be authorized to interrupt communications operations with the particular device identified in entry 522. In some embodiments, devices identified as unauthorized interrupters (e.g., the device identified in entry 528) may or may not override authorizations to interrupt based on the ranks of the devices (e.g., prevent a device from interrupting even though the device has a rank that would allow interrupting).

In some embodiments, interruption field column 501 may include authorized to interrupt field 510 and unauthorized to interrupt field 512. Interruption data column 521 may include identification entries 530 and 532 associated with fields 510 and 512, respectively. The particular device identified in entry 522 may or may not be authorized to interrupt communications operations with the devices identified in entries associated with fields 530 and 532, respectively. For example, when the particular device identified in entry 522 transmits a communications request during an ongoing communications operation with a device, the particular device may be authorized to interrupt provided that the device of the ongoing communications operation is identified in an entry associated with authorized to interrupt field 510 (e.g., independent of device rankings). As another example, the particular device may be prevented from interrupting if the device of the ongoing communications operation is identified in an entry associated with unauthorized to interrupt field 512 (e.g., independent of device rankings).

In some embodiments, the communications device may coordinate the data structures 500 associated with each devices such that if a first device is an authorized interrupter of a second device in the data structure of the first device, the second device authorizes the first device to interrupt in the data structure of the second device. In some embodiments, the communications device may automatically coordinate and update the data structures 500 when a particular data structure 500 is modified.

In some embodiments, the user may direct the communications device to modify the interruption authorizations for several devices based on an active mode of the communications device. For example, the user may direct the communications device to activate a “meeting” mode (e.g., change from a “normal” mode to a “meeting” mode) in which only specific devices are authorized to interrupt communications operations (e.g., only a spouse's device is authorized to interrupt). As another example, the user may direct the communications device to activate an “available” mode in which all devices may interrupt ongoing communications operations. Any other suitable mode with variations in interruption authorizations may be used.

In some embodiments, the communications device may include additional data structures (e.g., data structures 300, 400 and 500) for each mode. In some embodiments, when the communications device activates different modes, different sets of data structures 300, 400 and 500 may be used. The communications device may automatically switch between modes based on the time of day. For example, during work hours (e.g., 9-5 weekdays), the communications device may automatically activate a “work” mode in which only a spouse or children may interrupt communications operations. As another example, during weekends and evenings, the communications device may activate a “weekend” mode in which work-related devices (e.g., a boss's telephone) may not interrupt ongoing communication operations.

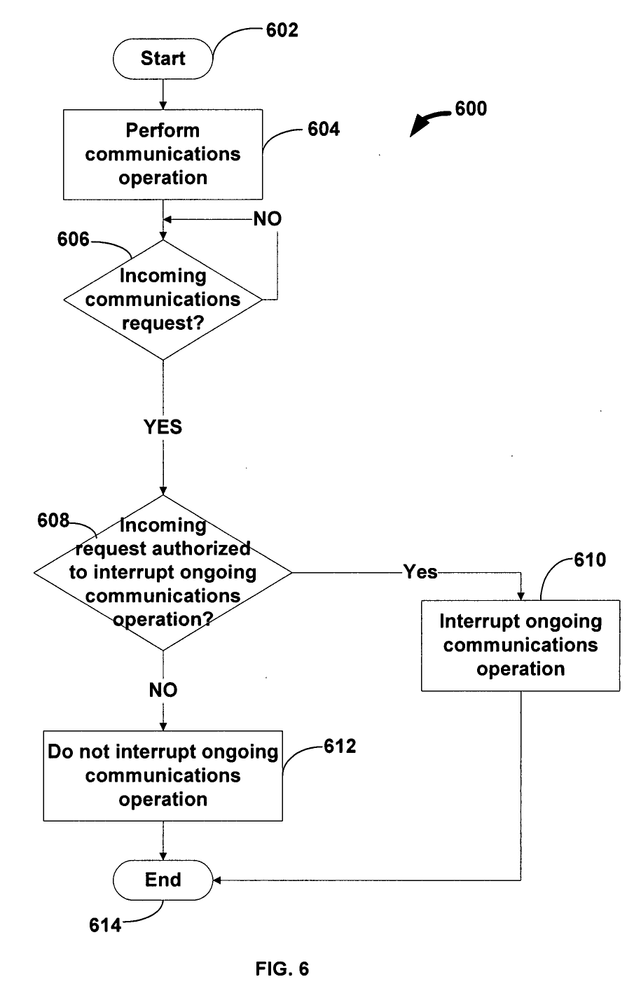

FIG. 6 is a flowchart of an illustrative process for determining whether to interrupt a current communications operation in accordance with one embodiment of the invention. Process 600 begins at step 602. At step 604, the communications device may perform a communications operation. For example, communications device 200 (FIG. 2) may perform a communications operation with a first device by transmitting data using communications circuitry 208 (FIG. 2). At step 606, the communications device may determine whether it is receiving a communications request from a second device. For example, communications device 200 may determine whether communications circuitry 208 is receiving a communications request from the second device. If the communications device determines that that the communications device is not receiving a communications request from a second device, process 600 may move back to step 606 and continue to monitor incoming communications requests.

If, at step 606, the communications device determines that the communications device is receiving a communications request from a second device, process 600 may move to step 608. At step 608, the communications device may determine whether the second device is authorized to interrupt the ongoing communications operation with the first device. For example, the communications device may determine whether the second device is authorized to interrupt the ongoing communications operations based on an exception stored in memory (e.g., based on entries in data structure 500 for the first device or on entries in data structure 500 for the second device).

As another example, the communications device may instead or in addition determine, based on the rankings or tiers associated with the first and second devices (e.g., determined from data structure 300, FIG. 3 or data structure 400, FIG. 4), which of the first and second devices has priority in communications operations. If the communications device determines that the second device is ranked higher than the first device, the communications device may determine, subject to any exceptions to the rankings and/or tiers, that the second device is authorized to interrupt the ongoing communications operation with the first device.

In some embodiments, the communications device may determine whether the second device is authorized to interrupt the ongoing communications operation with the first device based on the current mode of the communications device. For example, the communications device may have a plurality of modes, each associated with different authorizations for the devices with which the communications device may perform communications operations. The communications device may be operative to determine, based on the current mode, which set of interruption authorizations to use to determine whether the second device may interrupt the ongoing communications operation with the first device. If the communications device determines that the second device is authorized to interrupt the ongoing communications operation between the communications device and the first device, process 600 may move to step 610.

At step 610, the communications device may interrupt the ongoing communications operation. For example, the communications device may provide an audio signal indicating an incoming communications request. As another example, the communications device may instead or in addition provide a visual indication of an incoming communications request. In some embodiments, the interruption provided may be related to the second device (e.g., an interruption specific to the second device, an interruption related to an exception associated with the second device, or an interruption related to the rank or tier of the second device). Process 600 may then move to step 614 and end.

If at step 608, the communications device determines that the second device is not authorized to interrupt the ongoing communications operation between the communications device and the first device, process 600 may move to step 612. At step 612, the communications device may not interrupt the ongoing communications operation. For example, the communications device may provide no audio indication, visual indication, physical indication, or combinations of such indications of the incoming communications request. In some embodiments, the communications device may display a missed communications request notification (e.g., missed call) once the ongoing communications operation is terminated. Process 600 may then move to step 614 and end.

Priorities may be assigned to the devices with which the communications device may perform communications operations using any suitable approach. For example, the user may first select a device, and subsequently select a priority to be assigned to the device. A device may be selected using any suitable approach. For example, the user may select a device with the input mechanism of the communications device (e.g., select a device from a listing of available devices displayed on the communications device screen). As another example, the user may select and assign a priority to a device using a host device, and subsequently direct the host device to transmit the assigned priority to the communications device (e.g., when the device is synched).

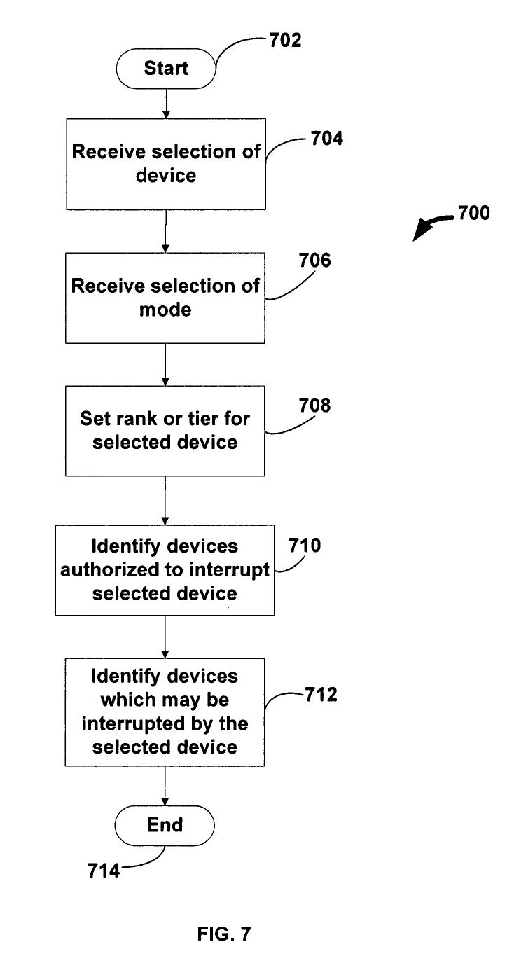

FIG. 7 is a flowchart of an illustrative process for setting priorities for devices in accordance with one embodiment of the invention. Process 700 begins at step 702. At step 704, the communications device may receive a selection of a device. For example, communications device 200 (FIG. 2) may receive a user input from input mechanism 206 (FIG. 2) to select a device displayed on display 204 (FIG. 2). As another example, communications device 102 (FIG. 1) may receive an indication from host device 120 (FIG. 1) that a user has selected a device using host device 120.

At step 706, the communications device may receive a selection of an operation mode (e.g., work mode). For example, communications device 200 may allow user selection of a mode, or it may automatically select a mode. The modes may include any suitable mode including, for example, modes associated with particular times of day (e.g., “work and “weekend” modes), modes associated with particular events (e.g., “meeting and “meal” modes), or modes associated with particular users (e.g., “spouse” mode when spending time with a spouse).

At step 708, the communications device may set a rank or tier for the selected device. For example, communications device 200 may receive an indication from the user of a rank or tier to assign to the selected device. As another example, communications device 200 or host device 120 may automatically assign a rank or tier for the selected device. Communications device 200 or host device 120 may use any suitable approach for determining which rank or tier to assign. For example, the rank or tier may be selected as a default, or based on user interactions with the communications device (e.g., based on prior user operations when the selected device interrupted a communications operation. The communications device may store the rank or tier using any suitable data structure. For example, communications device 200 may store rank or tier information in data structure 300 (FIG. 3) or data structure 400 (FIG. 4).

At step 710, the communications device may identify devices authorized to interrupt the selected device when the selected device is performing a communications operation. For example, communications device 200 may receive user indications of devices that are authorized to interrupt communications with the selected device independent of the relative rankings or tiers of the devices and selected device. As another example, communications device 200 may automatically identify devices that are authorized to interrupt communications with the selected device (e.g., based on user interactions with the communications device). Communications device 200 may store the authorization of the identified devices to interrupt communications operations using any suitable data structure, including for example data structure 500 (FIG. 5).

At step 712, the communications device may identify devices that may be interrupted by the selected device when the devices are performing a communications operation with the communications device. For example, communications device 200 may receive user indications of devices authorized to be interrupted by the selected device independent of the relative rankings or tiers of the devices and selected device. As another example, communications device 200 may automatically identify devices authorized to be interrupted by the selected device (e.g., based on user interactions with the communications device). Communications device 200 may store the identification of the devices that may be interrupted by the selected device using any suitable data structure, including for example data structure 500 (FIG. 5). Process 700 may then end at step 714.

The above described embodiments of the present invention are presented for purposes of illustration and not of limitation, and the present invention is limited only by the claims which follow.

What is claimed is:

1. A method for determining whether to interrupt an ongoing communications operation performed by a communications device, the method comprising:
directing the communications device to perform a communications operation with a first device;
receiving a request from a second device to initiate a communications operation with the communications device;
determining whether the second device is authorized to interrupt the ongoing communications operations with the first device; and
in response to determining that the second device is authorized to interrupt the ongoing communications operation with the first device, interrupting the ongoing communications operation with the first device.

2. The method of claim 1, wherein determining whether the second device is authorized to interrupt the ongoing communications operations with the first device further comprises determining at least one of the identity of the user of the second device, the time at which the second device transmitted the request to initiate a communications operation, and the location from which the second device transmitted the request to initiate a communications operation.

3. The method of claim 1, wherein interrupting the ongoing communications operation with the first device further comprises providing at least one of an audio interruption, a visual interruption, and a physical interruption of the ongoing communications operation with the first device.

4. The method of claim 1, wherein the ongoing communications operation is one of a voice communication and a data communication.

5. The method of claim 1, wherein the communications device is one of a cellular telephone, a personal e-mail device, a personal messaging device, and a computer.

6. A method for determining whether to interrupt a communications operation performed by a communications device, comprising:
directing the communications device to perform a communications operation with a first device;
receiving a request from a second device to initiate a communications operation with the communications device;
determining whether the second device is authorized to interrupt the ongoing communications operations with the first device; and
in response to determining that the second device is not authorized to interrupt the ongoing communications operations with the first device, continuing the ongoing communications operation with the first device without any interruptions.

7. The method of claim 6, further comprising determining that at least one of a rank and a tier associated with the first device is higher than at least one of a rank and a tier associated with the second device.

8. The method of claim 6, further comprising receiving a user indication of whether the second device is authorized to interrupt the ongoing communications operation with the first device.

9. The method of claim 6, further comprising automatically determining based on user interactions with the communications device whether the second device is authorized to interrupt the ongoing communications operations with the first device.

10. A communications device comprising communications circuitry and control circuitry, the control circuitry operative to:
direct the communications circuitry to perform a communications operation with a first device;
receive from the communications circuitry a request from a second device to initiate a communications operation with the communications device;
determine whether the second device is authorized to interrupt the communications operation with the first device; and
in response to determining that the second device is authorized to interrupt the ongoing communications operation with the first device, interrupt the ongoing communications operation with the first device.

11. The communications device of claim 10, wherein the control circuitry is further operative to determine at least one of the identity of the user of the second device and the location from which the second device transmitted the request to initiate a communications operation.

12. The communications device of claim 10, wherein the control circuitry is further operative to determine at least one of a rank and a tier associated with each of the first and second devices.

13. The communications device of claim 10, wherein the control circuitry is further operative to:
receive from the communications circuitry a request from a third device to initiate a communications operation;
determine whether the third device is authorized to interrupt the ongoing communications operation with the first device; and
in response to determining that the third device is not authorized to interrupt the ongoing communications operation with the first device, direct the control circuitry to continue the ongoing communications operation with the first device without any interruptions.

14. The communications device of claim 10, wherein the interruption comprises at least one of an audio interruption, a visual interruption, and a physical interruption.

15. A communications device comprising control circuitry operative to:
identify devices with which the communications device may perform a communications operation;
determine whether each identified device is authorized to interrupt communications operations between the communications device and the other identified devices; and
store the determined interruption authorizations for each device.

16. The communications device of claim 15, wherein the interruption authorizations comprise at least one of a rank and a tier associated with each identified device.

17. The communications device of claim 16, wherein the interruption authorizations comprise exceptions to the at least one of a rank and a tier associated with each identified device.

18. The communications device of claim 15, wherein the control circuitry is further operative to:
identify a plurality of modes of the communications device; and
determine, for each identified mode, interruption authorizations for each device.

19. The communications device of claim 15, wherein the control circuitry is further operative to determine at least one of locations and times for which each identified is authorized to interrupt communications operations.

20. A method for authorizing interruptions of communications operations between a communications device and another device, the method comprising:
identifying a plurality of devices with which the communications device is operative to perform communications operations;
determining whether each device is authorized to interrupt communication operations between the communications device and the other devices; and
storing the determined interruption authorizations for each device.

21. The method of claim 20, wherein the interruption authorizations comprise at least one of a rank and a tier associated with each device.

22. The method of claim 21, wherein the interruption authorizations comprises exceptions to the at least one of a rank and a tier associated with each device.

23. The method of claim 20, further comprising:
determining, for each authorized interruption, the type of interruption authorized; and
storing, in the communications device, the determined type of interruption authorized.

24. The method of claim 23, wherein the type of interruptions authorized comprises at least one of audio interruptions, visual interruptions, and physical interruptions.

25. The method of claim 20, further comprising:
identifying a plurality of modes of the communications device; and
determining, for each identified mode, interruption authorizations for each device.

26. A method for using a communications device, comprising:
conducting an in-progress telephonic communication between the communications device and a first device;
receiving an incoming telephonic communication from a second device;
determining whether to interrupt the in-progress telephonic communication; and
selectively interrupting the in-progress telephonic communication based on the determination.

27. The method of claim 26, further comprising:
determining not to interrupt the in-progress telephonic communication; and
displaying a missed call indication on a screen of the communications device after the in-progress telephone communication has ended.

28. The method of claim 27, wherein the missed call indication comprises at least one of the identity of the second device, the time at which the incoming telephonic communication was received, the priority of the second device, and the priority of the first device.

29. The method of claim 26, further comprising:
determining to interrupt the in-progress telephonic communication; and
emitting audio associated with the second device to interrupt the in-progress telephonic communication.

30. The method of claim 26, further comprising:
determining to interrupt the in-progress telephonic communication;
ending the in-progress telephonic communication; and
beginning to conduct a telephonic communication with the second device.

31. The method of claim 30, wherein ending the in-progress telephonic communication further comprises:
informing the user that the communication will be ended in favor of the second device;
automatically ending the in-progress telephonic communication; and
wherein beginning to conduct a telephonic communication with the second device further comprises automatically beginning to conduct a telephonic communication with the second device.
